(19) United States
(12) Patent Application Publication
(10) Pub. No.: US 2005/0173879 A1
(43) Pub. Date: Aug. 11, 2005

(54) Two-wheel type driving board

(76) Inventor: Sang-Ho Park, Seoul (KR)

Correspondence Address: Richard C Woodbridge;Synnestvedt Lechner & Woodbridge, PO Box 592, Princeton, NJ, 08542-0592, US

(21) Appl. No.: 10/480,187

(22) PCT Filed: Dec. 19, 2001
(86) PCT No.: PCT/KR01/02216

(30) Foreign Application Priority Data
Jun. 11, 2001 (KR) 2001/0032442

(51) Int. Cl. B62M 1/00

(52) U.S. Cl. 280/87.041

(57) ABSTRACT

The present invention relates to a two-wheel type driving in which the board is established with two wheels thereunder so that a user can enjoy the speed and the sense of equilibrium at high level because the user can control its driving direction by his body and the control stick. The board has disposed on its bottom portion a first wheel and a second wheel which each comprise one roller, respectively. The first wheel is capable of rotation by 360 degrees so that the driving direction of the board can be easily changed. That is, the connector is its one end connected at one end to the wheel driving axis establishing portion of the rotating plate and at its other end is connected to the axis holder which is established at the axis establishing portion so that the axis holder is rotated to control the connector in the front and backward directions thereby causing the first wheel to be rotated in the left and right direction.

### CROSS REFERENCE TO RELATED APPLICATIONS

This application claims the priority of PCT Application No. PCT/KR01/02216 filed on 19 Dec. 2001, and Korean Application 2001/0032442 filed on 11 Jun. 2001, the contents of which are hereby incorporated by reference.

### FIELD OF THE INVENTION

The present invention relates to a two-wheel type driving board in which two wheels are arranged in a straight line at the front side and the rear side under the board plate so that an user enjoys a sense of velocity and a sense of balance control because the user can drive the board by using the body and a control lever in left or right direction.

### BACKGROUND ART

A conventional skateboard is as shown in FIG. 11 a four-wheel type which is mounted four wheels 3′ and 4′ thereto. The conventional board 1′ is at its rear bottom portion attached a stopper 8′ for stopping the board by the fraction to the ground. The user puts one foot on the board 1′ and kicks off the ground by the other foot. Under this state when the board 1′ drives in an appropriate velocity the user puts feet on the board 1, thereby to enjoy under the state of being kept a balance of the body.

However, the conventional board 1′ as the foregoing descriptions gives to the user an enjoy only for the sense of velocity because the board 1 drives at the state of being kept the balance thereof without inclining in left or right direction. Accordingly, the driving velocity of the board 1′ is relatively slow thereby causing the satisfaction of the user to be decreased. Furthermore, because it is difficult to change the driving direction while driving, the user once stop the board 1′ and turn the driving direction thereby causing the user to be inconvenienced.

When the user intends to stop the board 1′ the user must push the rear portion of the board 1′ by foot in order for the stopper 8′ to contact to the ground. However, at this time the board 1′ lifts its front side thereby causing the board 1 to be placed in an unstable condition. Accordingly, the user cannot take a stable posture when he intends to stop.

### SUMMARY OF THE INVENTION

The present invention is invented to solve the above conventional problems, an object of the present invention is to provide a two-wheel driving board in which a user can enjoy the board in left or right direction by using the body and a control lever, and when a user intends to stop or decrease its velocity, the board can stop or decrease its velocity by the stepping member or the break lever according to the users selection.

In order to accomplish the above object the present invention provides a two-wheel type driving board comprises: a board plate; a front wheel and a rear wheel arranged in the straight line under the driving plate through an axis establishing member, said front wheel and rear wheel consisted of one roller, respectively, and said front wheel combined to a rotating member to be rotated 360 degrees so that the front wheel can freely change its driving direction; a connector connected its one side to a wheel establishing member of the rotating member, connected its other side to an axis holder which is axis-established to the axis establishing member so that the front wheel can freely change its driving direction in left or right by driving the connector in forward or backward according to the rotation of the axis holder; a control lever, which is mounted a break lever and a handle, combined to the one side of the axis holder via a central axis so that it can control the rotation of the axis holder; and stepping member, which is attached a rubber plate to be contacted or separated to or from the rear wheel, elastically established to the rear side of the board plate via a spring, said the stepping member connected to the break lever attached to the handle via a strong wire.

### BRIEF DESCRIPTION OF DRAWINGS

FIG. 1 is a disassembly perspective view showing an embodiment of the present invention.

FIG. 2 is a view showing a state that a front wheel is driven in left direction.

FIG. 3 is a view showing a state that a front wheel is driven in right direction.

FIG. 4 is a sectional view of a break stepping member according to the present invention.

FIG. 5 is a view showing a state that the stepping member is driven.

FIG. 6 is a partial sectional view of the assembly of an axis establishing member, an axis holder and a central axis of the control lever.

FIG. 7 is a sectional view of the assembly of the axis holder and the central axis of the control lever.

FIG. 8 is a sectional view of the driving state of the axis holder and the central axis of the control lever.

FIG. 9a is a dissembled partial perspective view of the control lever and the central axis thereof.

FIG. 9b is a view showing the state the control lever and the central axis thereof are dissembled.

FIG. 10 is an example view according to another embodiment of the present invention.

FIG. 11 is a bottom perspective view of a conventional skateboard.

### DETAILED DESCRIPTIONS OF THE PREPREFERRED EMBODIMENTS

Now, the present invention will be in detail described with reference to the drawings.

A two-wheel type driving board according to the present invention mainly contains a board plate 1 that serves to place a user's feet, a front wheel 3 and a rear wheel 4 which are consisted of one roller respectively. The front wheel 3 and the rear wheel 4 are arranged is straight line via an axis-establishing member 2.

The front wheel 3 can rotate by 360 degrees because it is combined to a rotation member 5 then it can freely change its driving direction. That is, the front wheel 3 can be its driving direction controlled because a connector 6 is on one end connected to a front wheel driving axis establishing member 5a and is on its other end connected to a rotation axis holder 7 so that the front and rear driving according to the rotation of the axis holder 7 can control the driving direction of the front wheel 3.

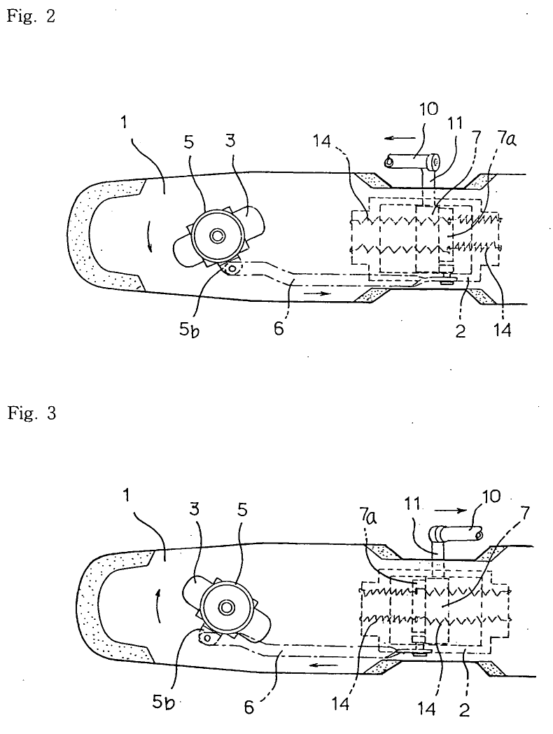

As shown in FIGS. 2 and 3, the front wheel 3 is at its driving axis establishing member 5a mounted a connecting member 5b, which can rotate itself. The connecting member 5b is connected to one end of the connector 6 in which the other end is connected to the one end of the axis holder 7, which is rotationally inserted to the axis-establishing member 2.

The rotating axis holder 7 has inserted at one end a control lever 10 so that pushing in the front or rear direction of the control lever 10 can force to rotate the rotating axis holder 7 by a predetermined degrees.

That is, the reciprocating rotation of the axis holder 7 can change the driving direction of the front wheel 3 in left or right direction. As shown in FIG. 2, if the control lever 10 is pushed in front direction, the axis holder 7 is rotated. Therefore, the connector 6 is driven backward so that the front wheel 3 has its direction changed in the left direction. As shown in FIG. 3, if the lever 10 is pulled backward the axis holder 7 is reversely rotated. Therefore, the connector 6 is driven forward so that the front wheel 3 has its direction changed to the right direction. That is, the driving direction of the front wheel 3 depends on the operation of the control lever 10.

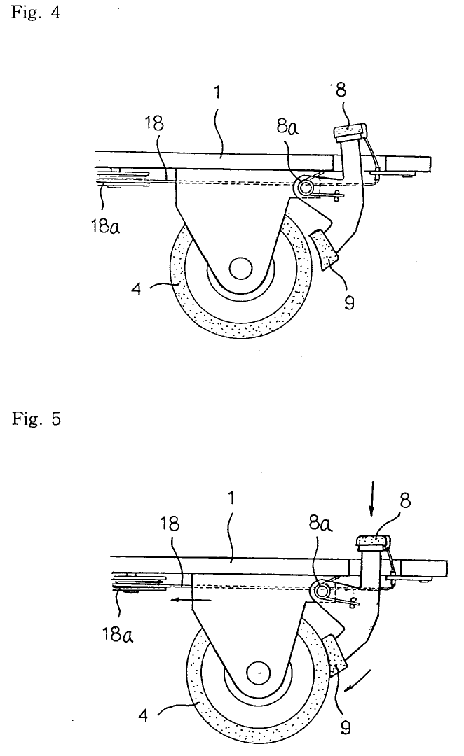

As shown in FIG. 4, the board plate 1 has at its rear side axis-established a stepping member 8 via spring 8a, which is attached a rubber plate 9 that contacted or separated to or from the outer surface of the rear wheel 4. The stepping member 8 is elastically established to one side of the bracket, which serves to rotationally support the rear wheel 4, by a spring 8a. The stepping member 8 and a break lever 17, which is mounted to a handle 16, are connected by a strong wire 18.

Accordingly, it is possible to stop the board because the rubber plate 9 is tightly contacted to the rear wheel 4 if the user steps the stepping member 8. Otherwise, if the user grasps the break lever 17, the rubber plate 9 attached to the stepping member 8 is tightly contacted to the rear wheel 4 thereby causing the board to stop because the wire 18 is pulled as shown in FIG. 5.

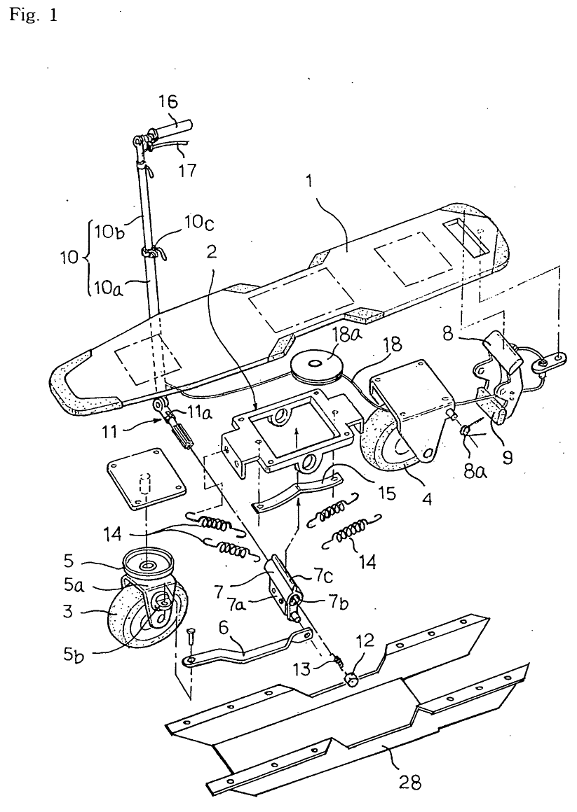

The axis holder 7 is one side as shown in FIG. 1 rotationally attached to the control lever 10 attached the break lever 17 and the handle 16.

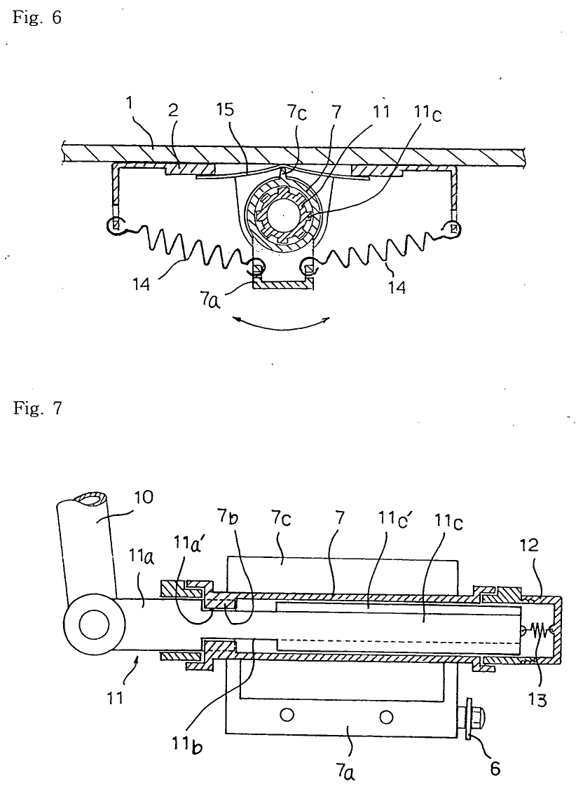

As shown is FIGS. 6 and 7, the axis establishing member 2 is in its central portion, attached to the axis holder 7, which comprises a continuously formed spring hanging member 7a.

The axis holder 7 has formed at its entrance portion a catching jaw 7b by a predetermined interval so that a catching groove 11a formed on the central axis 11 of the control lever 10 can insert the jaw 7b.

Between both ends of the square-shaped axis establishing member 2 and the spring hanging member 7a of the axis holder 7, a spring 14 is connected to both sides so that the spring hanging member 7a is elastically disposed at the central portion and that an upper protrusion 7c of the axis holder 7 is moved on the elastic member 15 secured to the axis holder 2 when the axis holder 7 is rotated either left and right. Therefore, the user can know the state that the spring hanging member 7a is placed at the central portion even without seeing because the user can easily feel the state that the protrusion 7c is caught by the recess portion of the inverted “V” shaped elastic member 15 [symbol] The above state means that the front wheel 3 is placed in the front facing direction and the control lever 10 is located in the vertical direction with respect to the board plate 1.

The axis holder 7 accepts the inserted central axis 11 of the control lever 10. The central axis 11 comprises, as shown in FIG. 7, an uneven portion 11a forming the catching groove 11a′ by a predetermined interval, a flat face 11b, for providing a predetermined moving distance, and an uneven portion 11c formed by the protrusion jaw 11c′. Between the rear end of the central axis 11 and a cap 12, which is formed at the rear end of the axis holder 7, the spring 13 is connected so that the central axis 11 has elasticity when inserted into the axis holder 7.

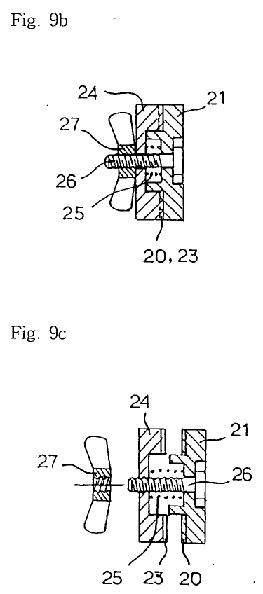

As shown in FIG. 9a the central axis 11 has its front end integrally attached to a circular member 21, which has a continuously established central combination hole 19 and a radial uneven-portion 20 around the hole 19. The control lever 10 has its lower end attached to a circular member 24, which includes a continuously established central combination hole 22 and a radial uneven portion 23 around the hole 22. The member 21 and the complementary member 24 are attached by a bolt 26 and a nut 27 via the spring 25. As shown in FIG. 9b, the uneven portion 23 of the assembling member 24 contacts the uneven portion 20 of the member 21 by the bolt 26 and the nut 27 so that the control lever 10 and the central axis 11 effectively become one body. As shown in FIG. 9c, by releasing the nut 27, the assembling member 24 is pushed by the spring 25. Therefore, the uneven portion 23 of the assembling member 24 is separated from the uneven portion 20 of the substrate so that the control lever 10 separated from the central axis 11 can rotate freely.

The assembling structure between the control lever 10 and the central axis 11 is for operating the control lever 10 and the central axis 11 together while driving the board. If the user wishes the operation degree of the control lever 10 to comply with the body condition as shown in FIG. 9c, the user first separates the lever 10 from the central axis 11 and controls the lever 10 by a desired degree and assembles the lever 10 and the central axis 11.

The control lever 10 and the handle 16 are assembled in the same manner as the assembling structure of the control lever 10 and the central axis 11. Therefore, the handle 16 is easily manipulated by the user without interrupting the control lever 10 thereby protecting the wrist of the user from inconvenience. The control lever 10 can be adjusted lengthwise according to the adoption of a conventional adjusting structure.

That is, the control lever 10 as shown in FIG. 1 comprises an outer accommodation tube 10a and an inner inserted tube 10b, which are combined or separated by a securing member 10c so that the user can adjust the length of the inserting tube 10b to comply with his body condition by using the securing member 10c.

Previously unexplained reference numeral 18a comprises a rotating member for winding the wire 18 and the reference numeral 28 comprises a protecting cover for protecting the driving portion at the lower portion of the board plate 1.

The front wheel 3 and the rear wheel 4 each have a round top tread portion so that the driving state of the board plate 1 can be more easily controlled and by inclining left and right.

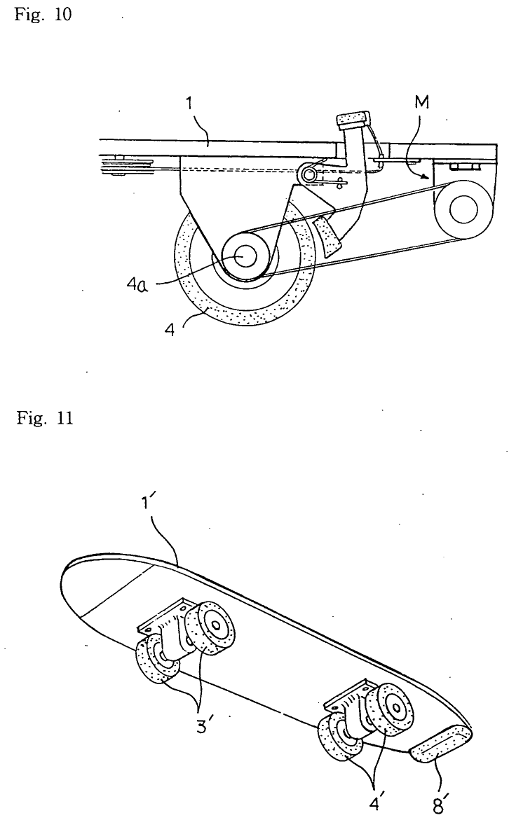

According to the other embodiment of the present invention as shown in FIG. 10, the board plate 1 has at its rear end established a power source unit such as a motor M so that the power of the motor M can be transmitted to the rotating axis 4a of the rear wheel 4 through a transmitting means.

Accordingly, the user can enjoy the board by either automatic control or a manual control.

According to the manual control mode, first the user puts one foot on the board plate 1 and kicks off the ground by the other foot thereby driving the board. After the board has an appropriate velocity the user puts both feet on the board plate 1.

Because the board according to the present invention has two wheels in which the front wheel 3 and the rear wheel 4 are disposed in a straight line, inclining in the left or right direction often occurs. Accordingly, the user must adjust the balance of the board plate 1 by his body and the control lever 10. This can provide the user a sense of velocity that can't be provided while driving a conventional four-wheel type board.

Furthermore, when it is necessary for the driving direction to be changed while driving, the user pushes the control lever 10 forward of the board plate 1 or pulls it rearward so that the axis holder 7, secured to the central axis 11 of the lever 10, rotates in the front or rear direction. Accordingly, as shown in FIGS. 2 and 3 the connector 6 moves forward or rearward so that the rotating member 5 of the front wheel 3 rotates in the left or right direction by a desired degree thereby to be changed the driving direction of the front wheel 3.

Accordingly, the board plate 1 can change its driving direction in left or right direction.

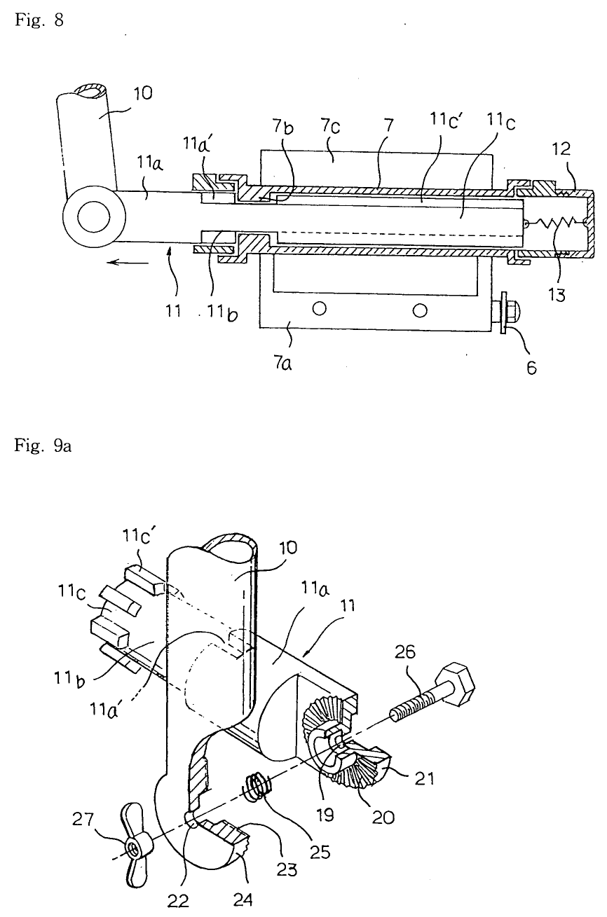

As shown in FIGS. 7 and 8 the central axis 11 of the control lever 10 comprises the uneven portion 11a formed with a groove 11a at a uniformed interval, the flat face 11b for providing the moving distance and the uneven-portion 11c alternately formed by the protrusion jaw 11c′. The axis holder 7 has at its entrance repeatedly formed the jaw 7b by a uniformed interval. Accordingly, if the central axis 11 is inserted into the axis holder 7 so that the protrusion jaws 7b of the axis holder 7 is inserted into the groove 11a′ of the unevenness portion 11a of the central axis 11, the central axis 11 and the axis older 7 are as shown in FIG. 7 combined with each other. Therefore, the rotation of the central axis 11 by the lever 10 forces to operate the axis holder 7 in order for the front wheel 3 to accomplish the change in front or right direction.

Because the spring 13 is connected between the rear end of the central axis 11 and the cap 12 of the axis holder 6, the central axis 11 has an elasticity when inserted to the axis holder 7. The combination state between the central axis 11 and the axis holder 7 can be maintained by elasticity of the spring 13.

As shown in FIG. 8, if the central axis 11 is pulled, the spring 13 has its length expanded by the moving distance on the flat face 11b so that the jaw 11b of the axis holder 7 is separated from the groove 11a′ of the central axis 11, and only the central axis 11 can freely rotate because of being separated from the axis holder 7 so that the control lever 10 can fold to the board plate 1 when not being driven thereby increasing its carrying and accommodating effect.

According to the foregoing, when the user intends to stop or decrease his velocity while driving the board, the user steps on the stepping member 8 with one foot so that the rubber plate 9 of the stepping member 8 contacts the outer face of the rear wheel 4 thereby suppressing the driving of the rear wheel 4. Accordingly, the board stops or decreases its velocity. If the user separates his foot from the stepping member 8, the stepping member 8 returns to its original state by reverse rotation caused by the elasticity of the spring 8a as shown in FIG. 4. The rubber plate is thereby separated from the rear wheel 4 and does not give resistance to the rear wheel 4.

Furthermore, instead when the user puts one foot on the stepping member, if the user grasps the lever 17 of the handle 16 so that the stepping member 8 is pulled below by the strong wire 18 connected to the break lever 17, the rubber plate 9 is tightly contacted to the outer face of the rear wheel 4 thereby suppressing the driving of the rear wheel 4 causing the board to stop or decrease its velocity.

If the user lets go of the break lever 17, the stepping member 8 returns to original state under the influence of the spring 8 so that the rubber plate 9 is separated from the rear wheel 4 as shown in FIG. 4.

Accordingly, the present invention has the advantage that the board can be stopped or its velocity decreased by stepping on the stepping member 8 or by grasping the break lever 17 while balancing on the board plate 1.

Meanwhile, the board plate 1 is its one side combined elastically to the supporting member attached to a coil spring thereto so that the board plate 1 can keep the vertical state while stopping for a long time. At this time, the coil spring is its one side combined elastically to the one side of the board plate 1 so that the supporting member is placed in parallel state to the board plate 1. Accordingly, the board plate 1 may not be interrupted from the driving.

### INDUSTRIAL AVAILABILITY

As the foregoing descriptions, the present invention can provide a two-wheel type driving board in which a front wheel and a rear wheel are disposed in a straight line under the board so that an user enjoys a sense of velocity and a sense of balance control because the user can enjoy the board by using the body and a control lever in left or right direction. Furthermore, when an user intends to stop or decrease its velocity, the board can be stopped or decreased its velocity by the stepping member or the break lever according to the user's desire.

1. A two-wheel type driving board comprising:
a board plate 1;
a front wheel 3 and a rear wheel 4 arranged in a straight line under the driving plate 1 through an axis establishing member 2, said front wheel 3 and rear wheel 4 each comprising at least one roller, respectively, and said front wheel 3 is attached to a rotating member 5 rotatable 360 degrees so that the front wheel 3 can freely change its driving direction;
a connector 6 connected one end to a wheel holding member 5a of the rotating member 5, and connected its other end to a axis holder 7 which is axis-established to the axis establishing member 2 so that the front wheel 3 can freely change its left or right driving direction by moving the connector 6 in forward or backward direction according to rotation of the axis holder 7;
a control lever 10, on which is mounted a break lever 17 and a handle 16, attached to the one end of the axis holder 7 via a central axis 11 so that it can control the rotation of the axis holder 7; and,
a stepping member 8, which is attached a rubber plate 9 to be contacted to or separated from the rear wheel 4, elastically connected to the rear side of the board plate 1 via a spring 8a,
wherein said stepping member 8 is connected to the break lever 17 and attached to the handle 16 via a strong wire 18.

2. The two-wheel type driving board according to claim 1, wherein said axis holder 7 has at its entrance portion repeatedly formed a catching jaw 7b, and between the square-shaped both end of the axis holding member 2 and a spring hanging member 7a connected to the axis holder 7, and a spring 14 is connected to the spring hanging member 7a and elastically placed in central portion,
wherein said axis holder 7 has at its central upper portion formed a protrusion 7c so that the protrusion 7c moves on an inverted “V” shaped elastic plate 15, which is secured to the axis establishing member 2, thereby to be easily placed the protrusion 7c in the central recess portion of the elastical plate 15 when the axis holder rotates in the left or right direction.

3. The two-wheel type driving board according to claim 1, wherein said control lever 10 comprises at its central axis with an uneven portion 11a formed by a catching groove 11a′ at a predetermined interval, a flat face 11b for providing a moving distance, and an uneven portion 11c formed a protrusion 11a′, and wherein said central axis 11 has its rear side connected to a cap 12 via spring 13.

4. The two-wheel type driving board according to claim 1, wherein said central axis 11 has at its front side established a continuously circular member 21 which includes formed a central combination hole 19 and a radial uneven portion 20, and wherein said control lever 10 has at its lower side established a continuously circular assembling member 24, which includes a central combination hole 22 and a radial uneven portion 23, wherein said uneven portion 20 of the substrate 21 and unevenness portion 23 of the assembling member 24 are combined via the spring 25 by a bolt 26 and a nut 27.
